(19) United States
(12) Patent Application Publication
(10) Pub. No.: US 2025/0322295 A1
(43) Pub. Date: Oct. 16, 2025

(54) Framework for Trustworthy Generative Artificial Intelligence

(71) Applicant: ServiceNow, Inc., Santa Clara, CA (US)

(72) Inventors: Lindsay Devon Brin, Montreal (CA); Joseph Béchard Marinier, Montreal (CA); Masoud Hashemi, Montreal (CA); Fabio Casati, Opfikon (CH); Yanick Chénard, Montreal (CA); Louis Philip Morin, Montreal (CA); Gabrielle Gauthier-Melançon, Montreal (CA)

(21) Appl. No.: 18/634,394

(22) Filed: Apr. 12, 2024

(51) Int. Cl. G06N 20/00

(52) U.S. Cl. CPC G06N 20/00

(57) ABSTRACT

An embodiment may involve obtaining a prompt for a large-language model (LLM), generating, using the LLM, an output of an artificial intelligence system, obtaining a validation model configured to detect a property in the output, the property indicating a fault in the output, generating, using the validation model on the output, a metric indicating likelihood of the property in the output, determining that the metric satisfies a fault threshold, and in response to determining that the metric satisfies the fault threshold, labeling the output as untrustworthy.

### BACKGROUND

Artificial intelligence systems, particularly those that employ large-language models (LLMs), have a variety of applications, from analyzing large datasets to generating summaries of digested text. However, LLMs are prone to a wide array of undesired behaviors, such as hallucinations, bias, and toxic behavior. But completely eliminating undesired behaviors from an LLM may result in the LLM being too “cautious” and providing less useful output in at least some situations.

### SUMMARY

Various implementations disclosed herein include overcome these and possibly other technical problems by providing techniques for evaluating the trustworthiness of artificial intelligence systems. To accomplish this, the implementations introduce a trustworthiness estimator, which may be used with a variety of different types of artificial intelligence technologies to determine the system's likelihood of generating an output that exhibits a certain property. Some properties analyzed for may be truthfulness, harmfulness, and readability.

The implementations accomplish this task by creating validation models for a number of properties to be evaluated in LLM output. Such a validation model provides an indication of the presence of a property in LLM output (e.g., a Boolean value of “yes” when the property is present or a value of “no” when the property is not present) or a degree of confidence of whether the property is present (e.g., between 0% and 100%) based on one or more validation metrics indicative of the property. In some embodiments, each validation model may provide additional factors related to the presence of the property, such as the relevant portion of the LLM output in which the property is found, reasoning for why a certain validation presence indicator was given, a ranked listing of different degrees of confidence for different presence indicators, or a revised prompt or other LLM input that may produce further LLM output that is more trustworthy.

Accordingly, a first example embodiment may involve obtaining a prompt for an LLM. The first example embodiment may also involve generating, using the LLM, an output of an artificial intelligence system. The first example embodiment may also involve obtaining a validation model configured to detect a property in the output, the property indicating a fault in the output. The first example embodiment may also involve generating, using the validation model on the output, a metric indicating likelihood of the property in the output. The first example embodiment may also involve determining that the metric satisfies a fault threshold. The first example embodiment may also involve, in response to determining that the metric satisfies the fault threshold, labeling the output as untrustworthy.

A second example embodiment may involve a computing system that may include one or more processors, as well as memory and program instructions. The program instructions may be stored in the memory, and upon execution by the one or more processors, cause the computing system to perform operations in accordance with the first embodiment.

A third example embodiment may involve a non-transitory computer-readable medium, having stored thereon program instructions that, upon execution by a computing system, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts an overview of the relationships between metrics, properties, and an analyzed LLM output, in accordance with example embodiments.

FIG. 6B depicts an overview of a validation model definition and training process, in accordance with example embodiments.

FIG. 6C depicts a logic flow for creating validation models, in accordance with example embodiments.

FIG. 6D depicts a logic flow for validation models, in accordance with example embodiments.

FIG. 7 depicts the structure of a trustworthiness estimator for LLM outputs, in accordance with example embodiments.

FIG. 8 depicts an example LLM system employing a trustworthiness estimator, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Technical Improvements

The embodiments herein provide a technical solution to a technical problem. One technical problem being solved is the presence of undesired behaviors in outputs from generative artificial intelligence systems such as LLMs. In practice, this is problematic because the presence of undesired behaviors may not only cause the ability of the LLM system to solve specific problems to decrease, but it may cause direct harms if the LLM system inadvertently outputs harmful or offensive content.

The prior art techniques do not allow for property-specific evaluation of LLMs; that is, the testing for only a single property that may indicate undesired behaviors. Thus, these techniques do not allow for granularity or flexibility in evaluating how an LLM performs with respect to certain aspects of its functionality.

The embodiments herein overcome these limitations by providing improved techniques to evaluate LLM systems for the presence of such undesired behaviors (or, conversely, the presence of desired properties). Moreover, the embodiments herein improve upon the prior art by allowing modularity in the selection of metrics. Particularly, the embodiments herein may be easily updated to make use of new or more useful metrics, and/or to allow users to select which metrics they wish to use to evaluate their LLMs.

In this manner, the creation, training, and use of LLM systems may be accomplished in a more accurate and robust fashion. This results in several advantages. First, if undesired behaviors can more readily be detected by the embodiments herein, software engineers and software testers may be able to accurately identify these behaviors within the functioning of their LLMs. Second, this allows for like comparisons of different LLMs, by objectively scoring each if the same metrics are used for each. In this manner, the selection and fine-tuning of LLMs to meet specific needs in terms of their properties can be achieved.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

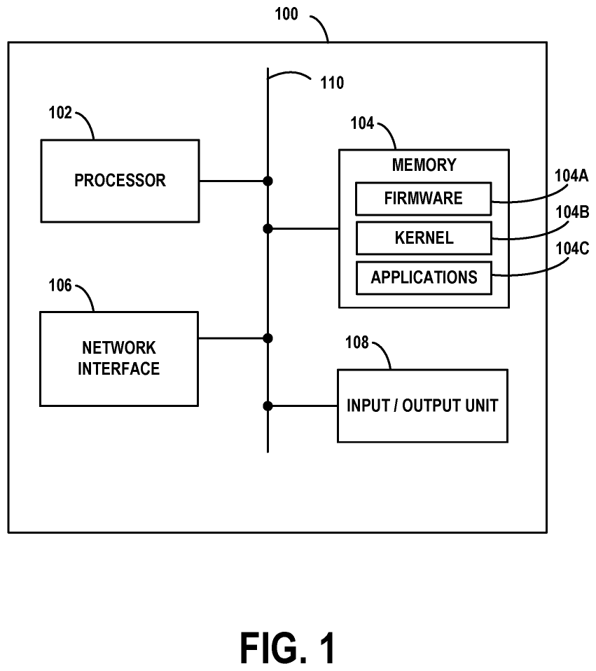

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

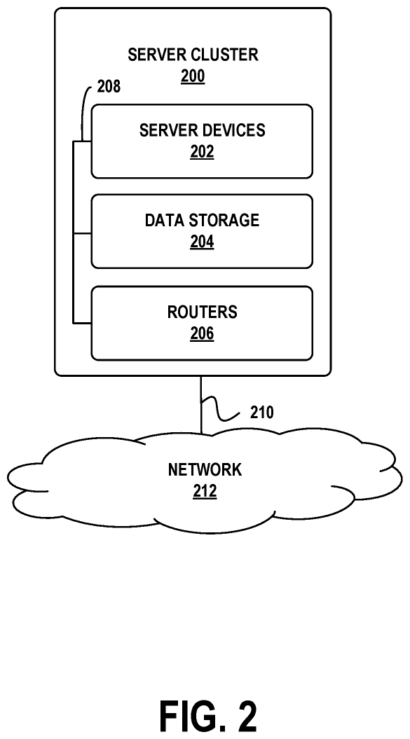

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PUP Hypertext Preprocessor (PUP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

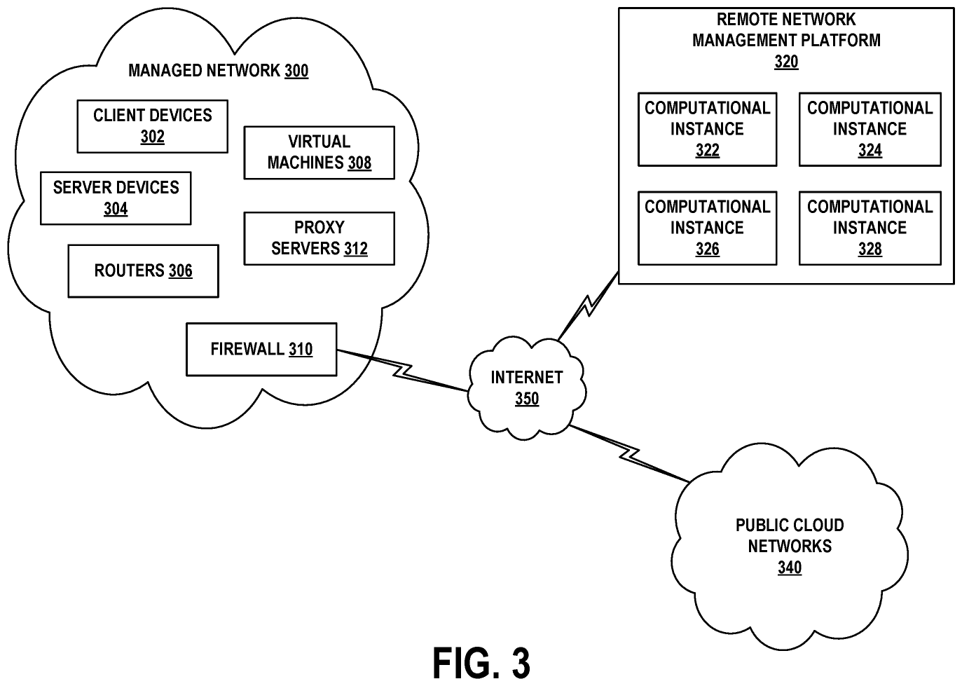

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

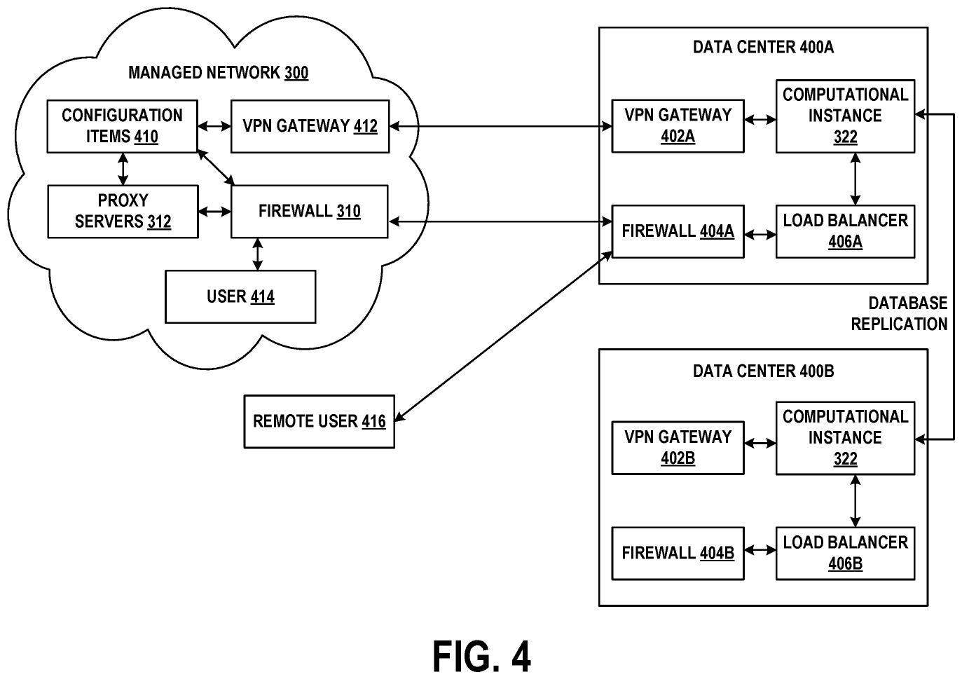

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

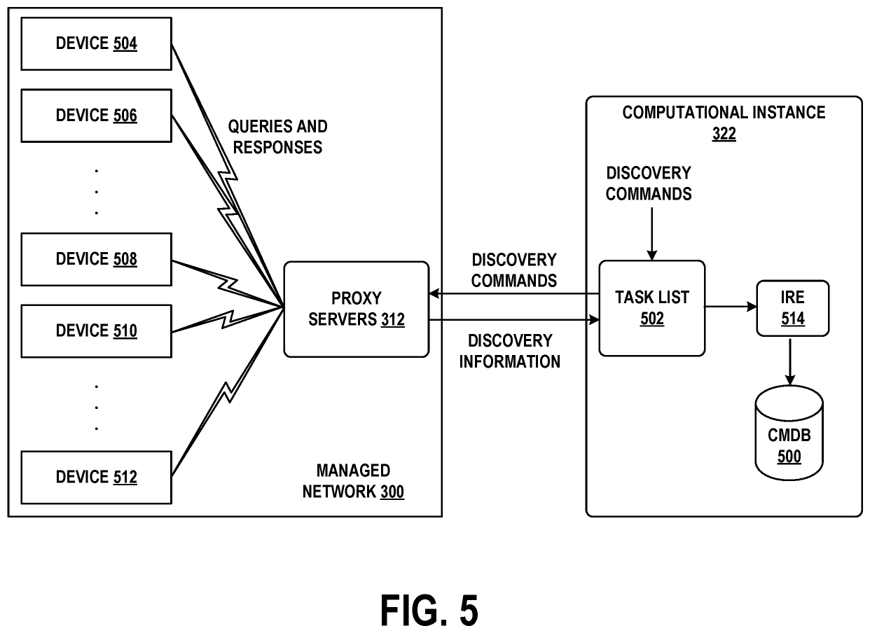

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Validation of Large Language Models

As stated previously, a remote network management platform may include one or more computational instances on which applications can be deployed for use by end users. These applications may relate to various aspects of discovery, incident management, knowledgebase management, virtual agents, and so on. Each application may have one or more graphical user interfaces that display content relevant to the application (e.g., a knowledgebase application may be able to search, display, and facilitate the editing of knowledgebase articles).

A remote network management platform may include features relating to the use of large language models (LLMs). These LLMs may be disposed within a computational instance of the remote network management platform or remotely accessible by way of a third-party service. LLMs may be employed to enhance user interaction with applications. For example, an LLM may be used for summarizing, generating, and/or comparing configuration items, incidents, knowledgebase articles, and other types of information.

### A. Large-Language Models

An LLM is an advanced computational model, primarily functioning within the domain of natural language processing (NLP) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### B. Evaluating LLM Performance and Risks

Despite their many uses and advantages over previous NLP systems, LLMs have limitations. For instance, LLMs may exhibit a variety of properties in their output that represent desired or undesired behaviors. Examples of such properties includes faithfulness, truthfulness, readability, harmfulness, bias, completeness, consistency, and security, each of which are described briefly below. Other properties may exist. Faithfulness, truthfulness, readability, completeness, consistency, and security may be considered desirable properties, while harmfulness and bias may be considered undesirable properties. In some cases, aspects of various properties may overlap with one another to an extent.

Faithfulness evaluates an LLM for its adherence to the content within its training data. Low levels of faithfulness may indicate the presence of “hallucinations,” which generally refers to incorrect, nonexistent, or nonsensical output. Two types of hallucinations are generally recognized: intrinsic hallucinations where the LLM manipulates information within the input text and produces an output that is not factual with respect to the input, and extrinsic hallucinations where the LLM appears to output information that has little or no basis in the input data whatsoever. Both present challenges to the usage of LLMs in environments where faithfulness to the training data has a high level of importance. Metrics associated with faithfulness may test the semantic similarity of LLM output in comparison to its training data.

Truthfulness evaluates the tendency of an LLM to output results that are factually correct. Truthfulness may also be referred to as factuality. Truthfulness may be evaluated on different levels. For example, metrics associated with truthfulness may test the semantic similarity of LLM output in comparison to a set of facts provided by a pre-established trusted authority. In another type of example, the LLM output may be tested for conformance with a belief or principle that may be important for how the LLM is expected to function (e.g., “all human beings deserve respect and dignity”).

Readability evaluates the tendency of an LLM to output coherent, fluent, and concise text (e.g., it measures the ease with which a reader can understand the output). For example, metrics associated with readability may consider spelling and grammatical errors, number of syllables per word, number of words per sentence, paragraph length, text formatting (e.g., use of logical headings and subheadings), consistency, etc.

Harmfulness evaluates the tendency of an LLM to output hate speech, violent content, sexually explicit content, misinformation, and/or exploitative content. For example, metrics associated with harmfulness may employ keyword-based detection, sentiment analysis, anomaly detection, and/or various types of NLP techniques.

Bias evaluates the tendency of an LLM to output content with political, cultural, gender, religious, racial, and/or confirmation biases. For example, metrics associated with bias may employ keyword-based detection, sentiment analysis, anomaly detection, and/or various types of NLP techniques (e.g., named entity recognition, topic modeling, and/or perspective analysis).

Helpfulness evaluates the tendency of an LLM to output content that answers the questions provided in a corresponding prompt. For example, metrics associated with helpfulness may employ semantic similarity, named entity recognition, and/or dependency parsing to determine the relevance of the LLM output to the prompt. In some cases, this may involve a readability analysis (e.g., as described above).

Consistency evaluates the tendency of an LLM to output content that is uniform over time (e.g., in terms of style, content, sentiment, and other linguistic or thematic features). For example, two outputs from an LLM that were generated from the same prompt or similar prompts may be compared (e.g. in terms of the percentage of shared words and/or shared phrases, textual overlap, and/or semantic similarity).

Security evaluates the tendency of an LLM to output content that does not inadvertently expose personally identifying information and other confidential information. For example, LLM outputs may be scanned for numeric patterns that match those of credit card numbers, social security numbers, driver's license numbers, and so on.

Each of these properties may be detected in LLM output through the evaluation of one or more metrics. In this disclosure, “metrics” and “validation metrics” may generally be used interchangeably unless otherwise specified. Values of the metric(s) associated with a property may provide a determination or a likelihood that the property is exhibited by the LLM output.

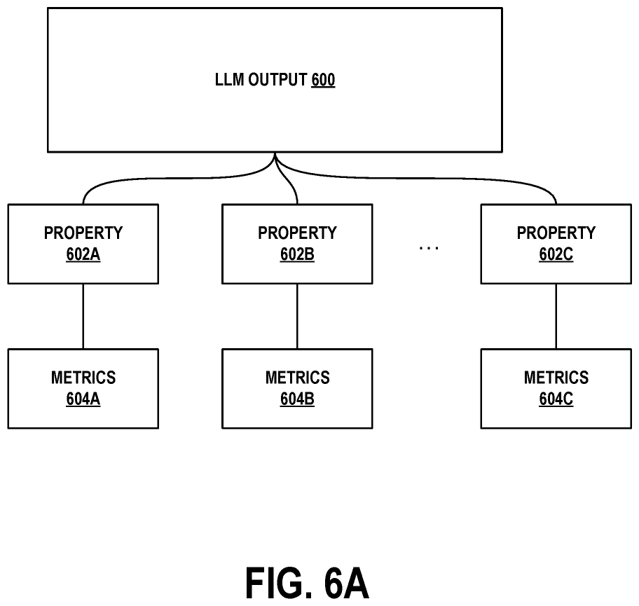

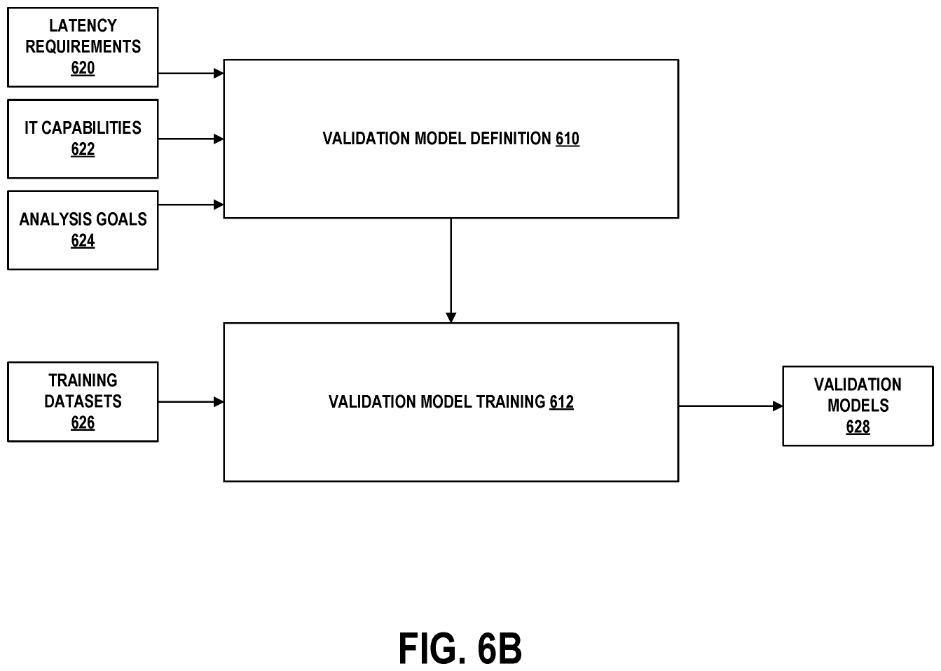

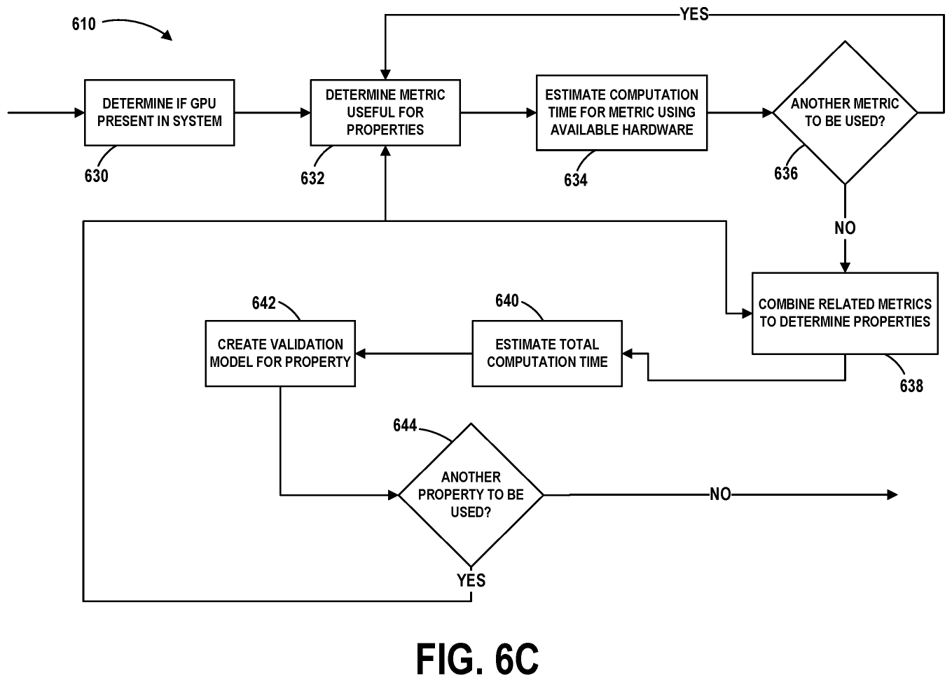

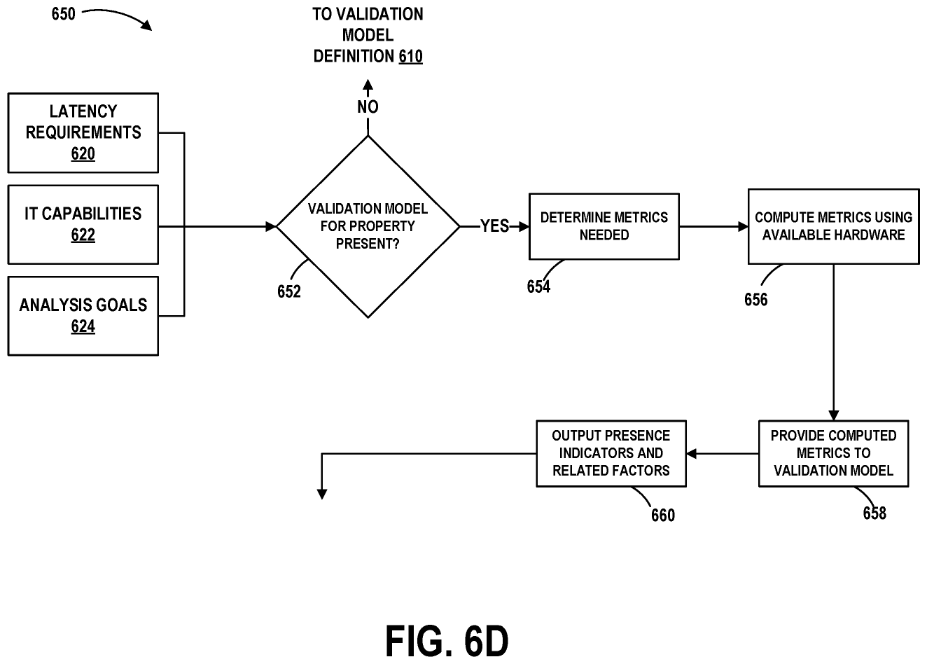

FIG. 6A depicts an example of these relationships. Particularly, an LLM output 600 may be tested for properties 602A, 602B, and 602C. In other examples, more or fewer proprieties may be considered. Each of these properties may be associated with one or more metrics. For example, property 602A is associated with metrics 604A, property 602B is associated with metrics 604B, and property 602C is associated with metrics 604C. In some cases, different properties can be associated with one or more of the same metrics.

Some LLMs are more likely to exhibit certain properties that others. For instance, general-purpose LLM-based chatbots may be programmed with “guardrails” so that the LLM is unlikely to produce untruthful or biased output. Nonetheless, LLMs are expected to be used in a wide variety of contexts and across a wide variety of cultures. In some contexts and/or cultures, it may be desirable for an LLM's guardrails to be loosened to some extent. Doing so may result in the LLM being less conservative and more creative in what it produces. The risk of some degree of untruthful or biased output may be acceptable. On the other hand, in other contexts (e.g., LLMs designed for use by school-aged children), any degree of harmfulness may be unacceptable.

It is possible to analyze LLM prompts separately for these properties as well as together with corresponding LLM output. Thus, for example, a harmfulness evaluation could take into consideration whether a prompt contains inappropriate language. Moreover, in some embodiments, other properties than that which have been described above may also be considered.

### VIII. Trustworthy Artificial Intelligence

In order to analyze LLMs for the properties described above, the embodiments herein introduce validation models for various properties. Each validation model makes use of one or more measured or computed validation metrics and provides an output that either indicates the presence of a property in LLM output (e.g., a Boolean value of “yes” when the property is present or a value of “no” when the property is not present) or a degree of confidence of whether the property is present (e.g., between 0% and 100%). These outputs, in either form, may be referred to as “presence indicators.” Some validation models may be trained machine learning models while other may employ other techniques (e.g., searching, pattern matching, indexing, and/or counting). In some cases, validation models may be purpose-built LLMs that are smaller and thus require less computational resources to invoke than general LLMs. In other cases, validation models may be constructed from pre-existing program code in the form of one or more functions, methods, or routines.

An overview of validation model creation and training is illustrated in FIG. 6B. Block 610 involves validation model definition. This block takes input of latency requirements 620, IT capabilities 622, and analysis goals 624.

Latency requirements 620 may specify how long training or operation of a validation model (or set of validation models) should take. For example, latency requirements 620 may be a mean latency, a median latency, or a maximum latency.

IT capabilities 622 may specify the processing and/or memory available for training or operation of validation models on a target computing platform. The target computing platform may query its hardware (e.g., by way of system call or another type of API) to determine how many CPUs and/or GPUs are installed and available for training, as well as the amount of memory availing for training. Information regarding CPU and/or GPU make and model, number of cores, and/or amount of on-board memory may also be considered.

Analysis goals 624 may be a list of properties for which validation models are to be defined. As noted above, there may be one validation model per property, and each property may be associated with one or more metrics.

Once the desired validation models are defined (e.g., by way of configuration file, interactive user interface, etc.), each may be trained at block 612. Some of the models may be trained in parallel to one another or all training may be performed serially. Training datasets 626 may facilitate the training. There may be one of training datasets 626 for each validation model. The training may be supervised or unsupervised. In some cases, such as for the evaluation of simpler metrics such as a word count, training may not be required and code module that perform such tasks may be provided instead.

One or more of training datasets 626 may also include predefined examples of “undesirable” behaviors. For example, a specific phrase or sentence may be considered offensive in certain contexts, and thus a training dataset may include such a phrase such that the model is trained to recognize it. Thus, when encountering such a phrase, the model may assign the LLM a higher “harmfulness” score.

Regardless, the output of block 612 may be validation models 628. These validation models may be fully trained and ready for deployment in a production computing environment.

FIG. 6C depicts a logic flow providing further detail regarding validation model definition 610. This logic flow may be executed automatically (e.g., based on configuration files) or interactively (e.g., with input via a graphical user interface).

Block 630 represents the beginning of the logic flow, which may be trigged by the decision to use an LLM and/or to validate the output of such a system. Block 630 may involve determining whether the target computing system on which the validation models will be trained or operate possesses hardware that accelerates machine learning related tasks.

Specific types of computer hardware components are well-suited for performing complex mathematical operations quickly and efficiently through parallelization. Parallelization refers to the ability of a processor to perform operations on data simultaneously without interference to each other. One particularly relevant example is matrix multiplication and other vector operations, which especially benefit from parallelization. Graphics processing units (GPUs) are one example of computer hardware that may parallelize such operations.

Many machine learning tasks are dependent on complex mathematical operations performed on large datasets, and thus hardware acceleration using GPUs or other components can reduce computation time. For instance, the training of machine learning models, especially varieties of neural network machine learning models, involves linear algebra operations such as dimensional transformations and optimization operations such as gradient descent. These operations may thus benefit from the parallelization capabilities that acceleration hardware may offer.

Other mathematical operations that may not be particularly optimized for parallelization may also be performed by a GPU or other acceleration hardware, which may free up resources in a central processing unit (CPU) of a computing system for other tasks.

While GPUs are discussed herein as an example, the presence of other acceleration hardware (e.g., custom ASICs or FPGAs) may also be determined in some embodiments. The logic flow may then proceed to block 632.

Block 632 may involve determining a specific metric that may be useful for indicating the presence of a specific property within the output of an LLM. Examples of these properties and metrics have been discussed above. The logic flow may then proceed to block 634.

Block 634 may involve estimating the computation time for the metric determined at block 632. In some embodiments, the determined metric may require complex mathematical operations to compute, and thus the presence of acceleration hardware as determined at block 602 may greatly speed up computation time, as described in more detail above. For example, harmfulness metrics may employ keyword-based detection, sentiment analysis, anomaly detection, and/or various types of NLP techniques, as noted above. NLP tasks that involve operations in parallel may particularly benefit from the presence of acceleration hardware, especially those that must take in a large amount of text for analysis.

If acceleration hardware is present, then the computation time for the metric may be estimated on the assumption that the acceleration hardware is used. However, if acceleration hardware is not present, then the computation time for the metric may be estimated on the assumption that one or more of the computing system's CPU will be used for computation.

The computation time for a metric may be calculated based on historical data (e.g., based on mean or median computation times for the same metrics in the past), based on input size, based on a big-O analysis of an algorithm used to evaluated the metric, and/or other factors. The computation time may thus be an estimate of actual computation time.

Block 636 may involve determining whether another metric is to be used for indicating the presence of a specific property. If another metric is to be used, the logic flow may return to block 632. Otherwise, the logic flow may proceed to block 638. As noted above, a single property may be associated with one or more metrics.

Block 638 may involve combining related computed metrics that may indicate the presence of a property. For example, if readability is the property, the metrics may be a number or percentage of words in the output that are misspelled, a grammar-rules compliance score generated by a deep neural network, a number of syllables per word, a number of words per sentence, and a measure of paragraph length. Other readability metrics may be used. The logic flow may then proceed to block 640.

Block 640 may involve estimating the total computation time for a property based on the estimated computation time for the metrics used. As noted before, this may vary based on a variety of factors including the presence of acceleration hardware such as GPUs. This computation time is referred to as the “latency” of the metric. Each contributes to the total runtime of the validation model (see below), and therefore may also be taken into account. In some cases, block 640 may determine that certain metrics can be calculated in parallel (e.g., based on the estimated computation time for each metric), and the total computation time may be reduced as a result.

Block 642 may involve creating a validation model that makes use of one or more measured or computed metrics and provides an output regarding a property. Validation models might or might not involve machine learning. The output is referred to herein as a “presence indicator”, in that it indicates the presence of a property in LLM output in either a Boolean manner (e.g., false when not present, true when present) or as a level of confidence that the property is present (e.g., 0 for no confidence to 100 for high confidence), for example.

A variety of different types of machine learning models may be used as validation models. In some embodiments, a validation model may be a neural network.

Neural networks are made up of layers of nodes appropriately called “neurons” as they approximate the function of brain cells. Each neuron is connected to others in the network, with each connection having its own mathematical weight. If an individual neuron's outputs exceed a threshold value, the neuron activates, sending data to other nodes, and so on. In some embodiments, a validation model may be a variant of neural network, such as a deep neural network or convolutional neural network.

In some embodiments, validation models may be purpose-built LLMs, as mentioned above. Some validation models may be trained machine learning models while other may employ other techniques (e.g., searching, pattern matching, indexing, and/or counting). Thus, non-machine-learning models may be used.

In some embodiments, a validation model may also identify the contribution of each metric in the computation of the output. In some embodiments, a validation model may also identify inputted metrics that negligibly affect the output, and “squash” (i.e. zero out) such metrics such that the “squashed” metric will have no or little effect on the output. The logic flow may then proceed to block 644.

In some embodiments, a validation model may operate on LLM prompts in addition to or rather than LLM outputs.

Block 644 may involve determining whether another property will be used. If so, the logic flow may return to block 638 to re-use existing computed metrics, or return to block 632 if a new metric should be computed. Otherwise, the logic flow may end.

At this point, one or more validation models for analyzing LLM outputs have been created. The logic flow may begin again to create more validation models, or the created validation models may then be trained, as depicted in FIG. 6B.

FIG. 6D depicts how, in some embodiments, latency requirements and the presence of acceleration hardware may influence the operation of validation models at inference time, as opposed to during validation model definition and training as illustrated in FIGS. 6B and 6C.

This is illustrated in logic flow 650. For example, latency requirements 620, IT capabilities 622, and analysis goals 624 may be taken into consideration by existing validation models, and choosing which already-created validation model may accomplish the task at hand.

However, it may be first determined if a validation model in accordance within the three above characteristics has already been created. This is represented within the logic flow at block 652. If such a model does not exist, the logic flow may end and proceed to validation model definition 610 in order that such a model may be created, as illustrated in FIGS. 6B and 6C. If such a model does exist, the logic flow may proceed to block 654.

Block 654 may involve determining the metrics used by the validation model in accordance with the latency requirements 620, IT capabilities 622, and analysis goals 624.

Block 656 may involve computing the metrics determined at block 654. The total computation time may also be recorded for future analysis and determination of latency for validation model definition 610 as illustrated in FIG. 6C.

Block 658 may involve providing the computed metrics to the validation model, which may then perform the property analysis according to its parameters (including latency requirements 620, IT capabilities 622, and analysis goals 624). In turn, block 660 may involve the validation model outputting presence indicators for a certain property, as well as certain related factors, which will be described in further detail below.

### A. Example of a Specific Validation Model

For purposes of illustration, an example of how a specific validation model is defined and created will be presented. This example will be based on the discussion of FIGS. 6B and 6C.

As noted above, latency requirements 620 may specify how long operation of a validation model should take, IT capabilities 622 may specify the processing and/or memory available for training or operating validation models on a target computing platform, and analysis goals 624 may be a list of properties for which validation models are to be defined.

Once latency requirements 620 and IT capabilities 622 are known, a determination may be made as to whether IT capabilities 622 are likely to satisfy latency requirements 620. If this is not the case, training or operating non-conforming validation models may be omitted or the non-conformance of these models may be brought to the attention of a user. Alternatively, fewer iterations of training may be used so that a one or more validation models conform with or are closer to conforming with latency requirements 620. For sake of this example, it will be assumed that one or more GPUs are present.

The analysis goals 624 for the validation model may be defined or chosen (e.g., specified in a configuration file or selected by a user). As an example, for a UK-specific system it may be desirable to evaluate LLM outputs compliance with UK currency formats, as well as following the norms of British English. To accomplish this goal, a readability validation model may employ metrics to evaluate compliance with UK standards of language and grammar. Such a model may output a presence indicator such as a degree of confidence that LLM output achieves these goals.

With this input, validation model definition 610 may proceed as follows. At block 630, it is determined that a GPU is present in the system.

Proceeding to block 632, the readability property useful for analyzing an LLM's compliance with UK-specific formats and language conventions may be determined. Thus, metrics associated with the readability property may also be determined. As noted above in the disclosure relating to FIG. 6A, metrics associated with properties and values thereof are what allow a validation model to provide a determination or a likelihood that the property is exhibited by an LLM output. Example metrics associated with readability may consider spelling and grammatical errors, number of syllables per word, number of words per sentence, paragraph length, text formatting (e.g., use of logical headings and subheadings), consistency, etc.

Metrics may also be modified to fit a specific use case or to reflect specific customer needs. In the UK-specific example described herein, a metric that considers spelling errors may also include the percentage of variable spelling words that use the proper regional spelling for the UK (e.g. “labour” versus “labor”) within an LLM output.

Once a metric associated with the readability property has been determined, the metric may be recorded for future use in validation model definition 610. This recordation may occur in the form of a configuration file or other data structure within computer memory.

Proceeding to block 634, the computation time for the regional spelling metric determined at block 632 may be estimated based on the presence of the GPU. For example, if a word, token, or symbol counting algorithm can be parallelized, the presence of the GPU may speed up computation and thus the estimate of the computational time may be lower. This computation time estimate may also be recorded as the metric above, within a configuration file or other data structure. The computation time may also be calculated based on historical data for the same metric stored within the configuration file or other data structures described above.

Proceeding to block 636, as an example, it may be determined that another metric may be used, and thus the logic flow returns to block 632.

Further metrics associated with the readability property may then also be determined. For example, another readability metric that may be determined to be useful may be a metric that measures the percentage of correct currency symbols (£ versus $ or €) or words (“pounds” versus “dollars” or “euros”) within an LLM output. This metric may also be recorded in the manner described above.

Proceeding to block 634, the computation time for the currency symbols/words metric may be estimated based on the presence of the GPU. As before, the presence of the GPU may speed up computation and thus the estimate of the computation time may be lower when a GPU is present. Alternatively, the estimate may be based on past computations of the same metric.

Proceeding again to block 636, it may be determined that there are no more metrics to be used, and thus the logic flow may proceed to block 638. Block 638 may involve combining the two determined metrics for use in a validation model designed for UK-region readability.

Block 640 may involve estimating the total computation time for the two determined metrics based on the individual computation times estimated at block 634. This may vary based on a variety of factors, as described above, including the presence of acceleration hardware and whether one or more of the metrics may be calculated in parallel.

Block 642 may involve creating a validation model specifically designed to take in the two metrics determined above and provide an output. The output is referred to as a presence indicator, as defined above, and may include a degree of confidence regarding UK-region readability on a scale from 0% to 100%, which may be used to evaluate an LLM's propensity for certain behaviors or compliance with specific goals. A high value may allow a user to determine that the LLM is ready for deployment into a production environment, while a low value may indicate that the LLM requires further development and/or fine-tuning before it is ready for such deployment.

As noted above, a validation model may or may not involve machine learning. However, in the current example of the UK-region readability validation model, this disclosure contemplates the use of a machine learning model.

One example of a machine learning model contemplated above, deep neural networks, are those neural networks with more than three layers. Generally, such deep neural networks consist of an input layer, one or more “hidden” layers, and an output layer. The input layer may be constructed to take in data in a certain format—in this example, the format may be numerical, such as the metrics associated with the readability property as described above.

Thus, for the example of the UK-region readability validation model, this disclosure contemplates the creation of a deep neural network according to the principles described above. The logic flow may then proceed to block 644. As another property is not to be used in the current example, the logic flow with regard to FIG. 6C may end.

Returning to FIG. 6B, the validation model may be trained as part of validation model training 612, as FIG. 6C described validation model definition 610.

Validation model training 612 may involve training the model. For neural networks, the training process involves adjusting the weights of the connections between neurons within the network using algorithms such as backpropagation, in conjunction with optimization techniques like stochastic gradient descent, to minimize the difference between the model's output and expected output.

In this example, the training datasets 662 that the validation model may be trained on may include past measured currency and spelling metrics and their associated validation model presence indicators and LLM outputs used to generate such indicators. By training a created validation model on this sort of data, a more accurate output from the validation model may be obtained.

Once the validation model has been created and trained, it may be implemented for use in a trustworthiness estimator as described in the following section.

Such metrics as described above are given as examples—other metrics are possible to be used in some embodiments.

### B. Trustworthiness Estimator

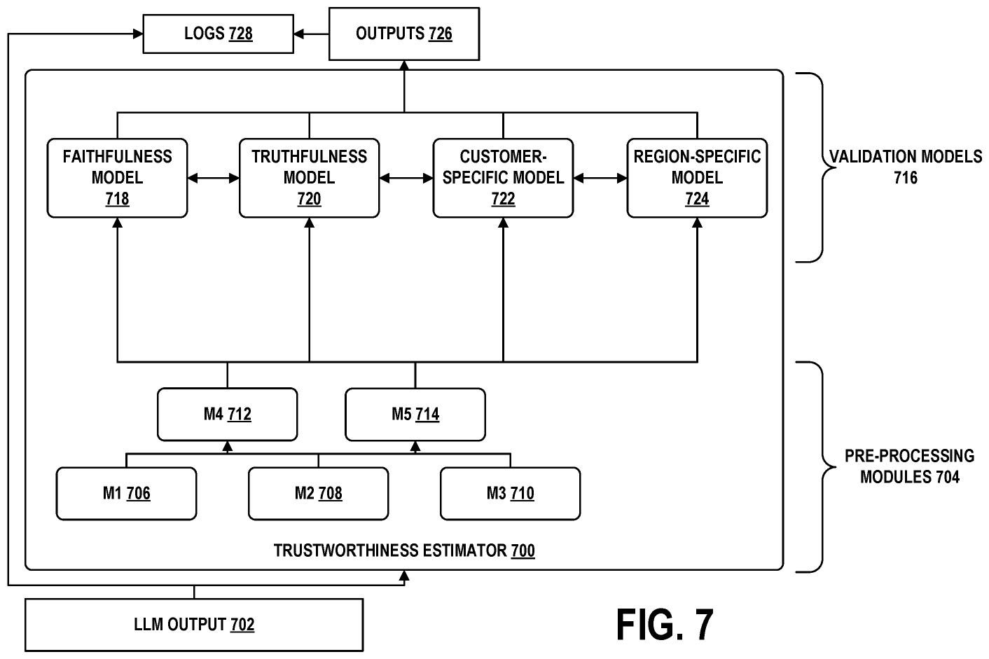

FIG. 7 illustrates an internal view of a trustworthiness estimator 700, which performs the task of evaluating LLM output for properties. While LLMs are used herein as an example, other generative artificial intelligence systems, non-generative artificial intelligence systems, or other types of systems may also be used.

The trustworthiness estimator 700 may take in LLM output 702 from an LLM. In some embodiments, LLM output 702 may be the output of an LLM in response to a prompt.

The trustworthiness estimator 700 may then pass the LLM output 702 through pre-processing modules 704, which include M1 706, M2 708, M3 710, M4 712, and M5 714. Such modules may or may not be machine learning models. Nonetheless, they are representative of optional pre-processing steps that may be performed on the input or modules that may compute metrics required by the validation models 716.

In some embodiments, the pre-processing modules 704 may be algorithms or applications that performs operations on the input. For example, the input may need to be compressed, or converted into a data format compatible with the other models within the trustworthiness estimator 700. While five modules are illustrated in FIG. 7 for example purposes, some embodiments may involve fewer pre-processing modules, while others may involve more.

The function of the trustworthiness estimator may, in some embodiments, require the real-time computation of certain metrics that are then fed into the validation models so that they may properly make their probability prediction, and thus the latency (e.g. runtime) of each model may vary. Such computation is in real time as the user may be awaiting an answer from the LLM. In some embodiments, this real-time computation of metrics may be performed by the pre-processing modules 704, and the metrics may be provided along with the LLM output 702 to the validation models 716.

For example, following the example UK-region readability validation model given above in relation to FIGS. 6B and 6C, a pre-processing module may count the occurrences of the correct currency symbols (£ versus $ or €) or words (“pounds” versus “dollars” or “euros”). This metric may then be used for the calculation of a UK-region readability presence indicator.

After pre-processing of LLM output 702, LLM output 702 may be passed to the validation models 716, each of which has been created and trained to determine the prevalence of its respective property in LLM output 702. The validation model creation and training process has been described in more detail above in the description with respect to FIGS. 6A-6C.

As the training process for the validation models is often dependent on the hardware capabilities of the system the models run on, this may lead to differing performance among validation models. As noted above, hardware may greatly accelerate the computation of metrics and training of the validation models. Different validation models may be trained for differing amounts of time, or rely on different numbers or types of metrics to make their analysis decisions. These trade-offs may be considered by those making use of the trustworthiness estimator and its constituent validation models.

Four validation models are illustrated in FIG. 7 as part of the validation models 716: a faithfulness model 718, a truthfulness model 720, a customer-specific model 722, and a region-specific model 724.

The faithfulness model 718 may be trained to evaluate whether the LLM output 702 exhibits signs of intrinsic or extrinsic hallucination, as described above. It may output a presence indicator in the form of a Boolean value representing whether the LLM output 702 contains hallucinated information.

The truthfulness model 720 may be trained to evaluate whether the LLM output 702 contains correct factual information—for example by testing the semantic similarity of LLM output in comparison to a set of facts provided by a pre-established trusted authority, as described above. Such a trusted authority may be accessed at runtime over the Internet, if the system contains Internet-access capabilities. This authoritative lookup may occur during a pre-processing step, as a possible metric that could be input into the truthfulness model 720 could be a quantitative NLP analysis result of whether LLM output 702 confirms with a specific principle. Such a metric may be computed by one or more of the pre-processing modules 704.

As noted above, other validation models beyond those given as examples in this disclosure may be utilized. For instance, a validation model may be trained to analyze for a property that is customer-specific or limited to a specific use case. Thus, in some embodiments, the customer-specific model 722 may be used to accomplish this task.

The region-specific model 724 may be trained to identify whether the input complies with regional standards concerning formatting and language. For example, a UK-specific system may evaluate LLM outputs compliance with UK time and measurement units and formats, as well as following the grammatical and spelling norms of British English. The latter may be accomplished with a UK-region readability validation model given as an example above.

A similar process may occur for each of the other constituent validation models within the trustworthiness estimator 700 as well, though using different input metrics and model architectures in some embodiments.

The validation models 716 each provide a presence indicator and propagate their presence indicators to validation outputs 726. The presence indicators may be used to determine whether and/or with what likelihood the LLM exhibits each property.

In some embodiments, each validation model may also provide other related factors to the presence indicators. For example, such factors may include the relevant portion of LLM output 702 to presence indicators, provide reasoning for why a certain presence indicator was given, rank different outputs if more than one were given, and generating an improved prompt or other input that may improve future LLM outputs. Each of these related factors may also be propagated to and included in the validation outputs 726.

Both LLM output 702 and validation outputs 726 may be recorded in the logs 728 for analysis and quality assurance. Such a log may take the form of a text file, metadata file, or database file.

In some embodiments, the trustworthiness estimator may operate in accordance with the logic flow illustrated in FIG. 6D. For example, the metrics computed at block 656 may be computed by the pre-processing modules 704 of FIG. 7. Additionally, the trustworthiness estimator 700 may take in latency requirements, IT capabilities, and analysis goals directly, which may allow the trustworthiness estimator 700 to make use of only certain validation models 716. For example, a validation model that takes a long time to compute its presence indicator may be “skipped” over by the trustworthiness estimator 700 if the analysis goals require a quick answer or evaluation to the output.

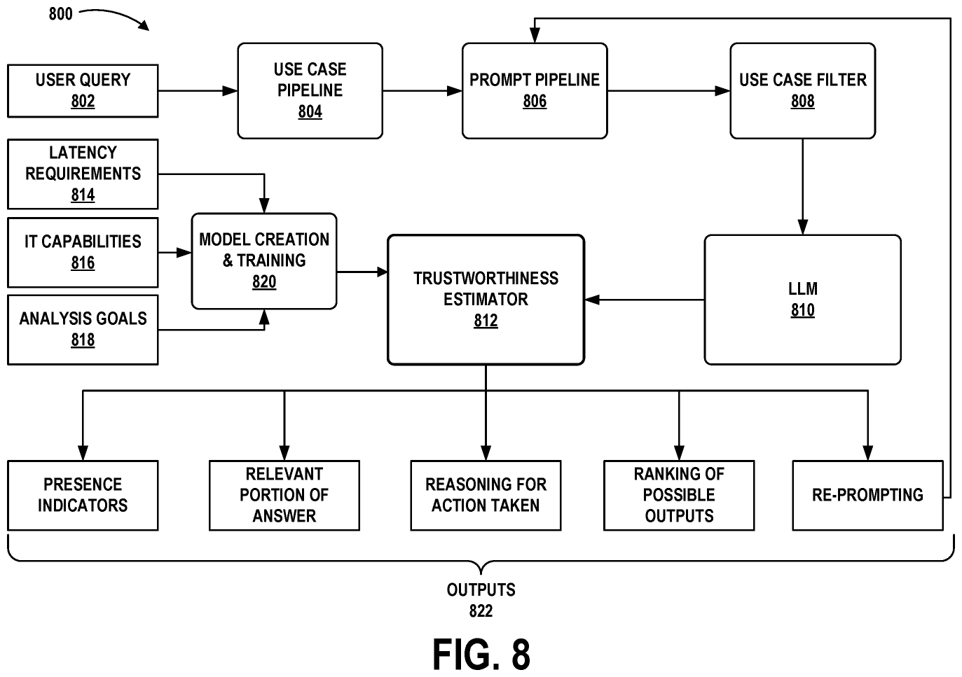

An example LLM system that implements a trustworthiness estimator is illustrated in FIG. 8. The LLM system 800 begins an example workflow with a user query 802, which, in an LLM context, may be a question, search query, or other text-based input.

This user query may then be provided to a use case pipeline 804. In some embodiments, if the user query is a search query, the use case pipeline 804 may search an existing database (e.g. a knowledgebase) and determine if a required answer is already within a database, and return the required answer to the user without needing to invoke other components of the LLM system.

The user query may then be provided to a prompt pipeline 806. In the context of LLM systems, this may include appending the user query to “system prompts,” that is, predetermined inputs that set the guidelines for the LLM's proper functioning. In some embodiments, this may involve input that specifies output format or other factors. The prompt pipeline 806 may then output the completed prompt for further use.

The completed prompt may then be provided to a use case filter 808, which may reject prompts that are irrelevant to the desired use case. Such a use case filter is helpful to avoid frivolous queries that may have a higher chance of causing the LLM to generate output that is unrelated to its intended use. For instance, if the LLM application in question is a technical support chatbot, the use case filter 808 may reject a prompt that asks what the weather was in Greenwich, London, on Jan. 1, 1970.

This filtered prompt may then be provided to the LLM (or other artificial intelligence system) to respectively obtain the generated LLM output.

This generated LLM output may then be provided to a trustworthiness estimator 812. The functioning of the trustworthiness estimator has been described in detail above in relation to FIG. 7 and the trustworthiness estimator 700 therein.

The validation model creation and training process 820 that builds and trains the validation models within the trustworthiness estimator has also been described in detail above in the disclosure relating to FIGS. 6A-6C. As described above, the validation model creation process and training process 820 takes in, among other things, latency requirements 814, IT capabilities 816, and analysis goals 818 in order to create and train validation models that will accurately evaluate the generated LLM output. In some embodiments, the trustworthiness estimator 812 may take in latency requirements 814, IT capabilities 816, and analysis goals 818 directly in addition to such factors informing the model creation and training process 820, as described in relation to FIG. 6D above.

As described in detail above with regard to the example trustworthiness estimator 700 and its outputs 726, each validation model within a trustworthiness estimator 812 provides a presence indicator and propagates its presence indicators to outputs 822. The presence indicators may be used to determine whether and/or with what likelihood the LLM exhibits each property. The outputs 822 may then be used for troubleshooting, development, and other evaluation of the LLM, other LLMs, and/or other artificial intelligence systems.

In some embodiments, each validation model may output other related factors to the presence indicators, for example the portion of the LLM output relevant to the presence indicator, provide reasoning (e.g. a specific confidence interval range) for why a certain output was given, rank different outputs in order of confidence if more than one were given, and generating an improved prompt or other text input for the LLM that may improve the outputs with regard to one or more properties. These related factors may also be included among the outputs 822 along with the presence indicators from each of the validation models within the trustworthiness estimator 812.

### IX. Example Operations

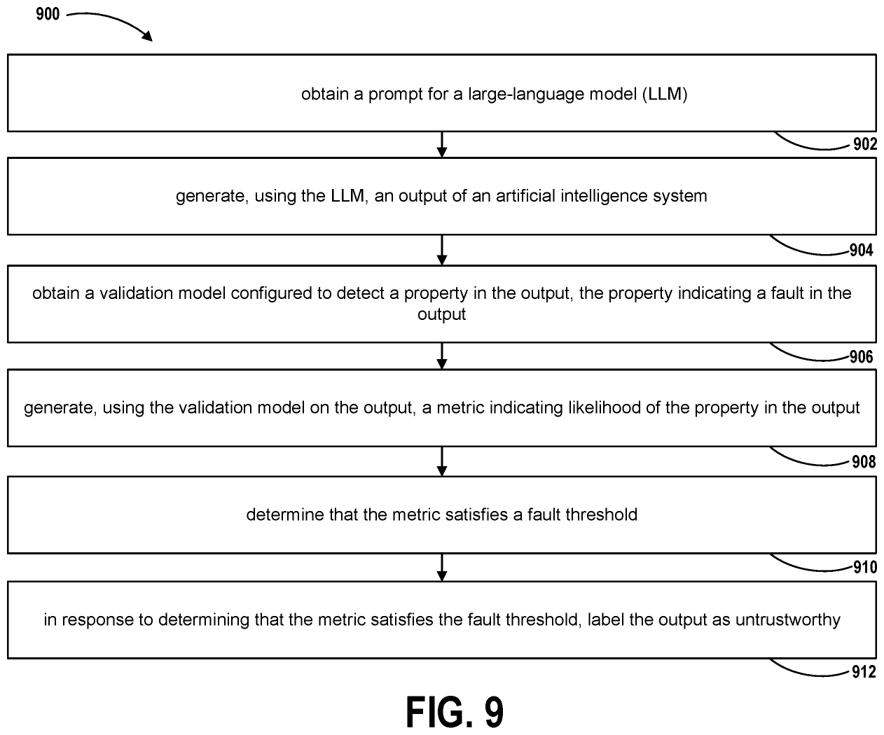

FIG. 9 is a flow chart illustrating an example embodiment. The process 900 illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 902 may involve obtaining a prompt for a large-language model, referred to herein as an LLM.

Block 904 may involve generating, using the LLM, an output of an artificial intelligence system.

Block 906 may involve obtaining a validation model configured to detect a property in the output, the property indicating a fault in the output. Block 906 and possibly related activities represent a technical improvement as discussed above, as individual validation models for each property (e.g., faithfulness, truthfulness, readability, harmfulness, bias, completeness, consistency, and/or security) allows for flexibility in evaluating LLM performance. Particularly, a specific property may be evaluated, allowing for more particularity in determining what aspects be improved when fine-tuning LLMs.

Block 908 may involve generating, using the validation model on the output, a metric indicating likelihood of the property in the output. Such metrics indicating likelihood of the property in the output are distinct from the “validation metrics” discussed previously in this disclosure, and in some embodiments may be presence indicators as discussed above. This also represents a technical improvement, as multiple validation models may be used to evaluate an LLM for multiple different properties, allowing for even more specificity when improving LLMs. Additionally, validation models may be easily updated or replaced within the embodiments herein, allowing for new, useful, and/or improved validation metrics and presence indicators to be used in LLM evaluation. In this manner, trustworthiness of the LLM can be objectively evaluated based on customizable sets of properties.

Block 910 may involve determining that the metric satisfies a fault threshold.

Block 912 may involve in response to determining that the metric satisfies the fault threshold, labeling the output as untrustworthy.

In some embodiments, the process may further involve, after obtaining the prompt for the LLM, evaluating the prompt, wherein evaluating the prompt comprises at least one of: determining whether an answer to the prompt exists within a database, appending predetermined inputs related to operational guidelines for the LLM to the prompt, or providing the prompt to a use-case filter configured to reject prompts unrelated to predetermined categories.

In some embodiments, the process may further involve, in response to determining that the metric satisfies the fault threshold, obtaining a second prompt for the LLM, wherein the second prompt is intended to reduce likelihood of the property in further output from the LLM.

In some embodiments, the process may further involve, based upon the second prompt, generating, using the LLM, a second output of the artificial intelligence system, and generating, using the validation model on the second output, a second metric indicating the likelihood of the property in the second output.

In some embodiments, the process may further involve determining that the second metric does not satisfy the fault threshold, and in response to determining that the second metric does not satisfy the fault threshold, labeling the second output as trustworthy.

In some embodiments, the process may further involve, in response to labeling the second output as trustworthy, modifying the validation model based on the second output being trustworthy.

In some embodiments, the fault in the output relates to one or more of bias, hallucination, toxic behavior, threat, or readability.

In some embodiments, the metric indicating the likelihood of the property in the output comprises one of a Boolean value or a degree of confidence.

In some embodiments, obtaining the validation model comprises determining one or more validation metrics related to presence of the property within the output, creating the validation model that outputs a presence indicator of the property based upon the validation metrics, and training the validation model based on datasets containing prior examples of the validation metrics.

In some embodiments, training the validation model based on datasets containing prior examples of the validation metrics comprises determining that acceleration hardware is present in a computing system, and, in response to determining that acceleration hardware is present, utilizing parallelization capabilities of the acceleration hardware during training of the validation model.

In some embodiments, the process may further involve, in response to labeling the output as untrustworthy, outputting related factors to the likelihood of the property in the output, wherein the related factors comprise a portion of the outputs relevant to the metric or reasoning for why the metric was provided.

In some embodiments, the process may further involve, in response to determining that the metric satisfies the fault threshold, obtaining a second prompt for the LLM, wherein the second prompt is intended to reduce presence of the property indicating the fault in the output, based upon the second prompt, generating, using the LLM, a second output of the artificial intelligence system, generating, using the validation model on the second output, a second metric indicating likelihood of the property in the second output, and, based on the metric and the second metric, ranking the prompt and the second prompt.

In some embodiments, generating, using the validation model on the output, the metric indicating the likelihood of the property in the output comprises computing, by one or more pre-processing modules, a validation metric related to presence of the property within the output, and propagating the computed validation metric to the validation model.

In some embodiments, the validation metric comprises one or more of semantic similarity with a reference dataset, conformance to a pre-determined principle, a sentiment analysis score, or a determination that pre-determined numeric patterns exist in the output.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a prompt for a large-language model (LLM),
generating, using the LLM, an output of an artificial intelligence system;
obtaining a validation model configured to detect a property in the output, the property indicating a fault in the output;
generating, using the validation model on the output, a metric indicating likelihood of the property in the output;
determining that the metric satisfies a fault threshold; and
in response to determining that the metric satisfies the fault threshold, labeling the output as untrustworthy.

2. The method of claim 1, wherein after obtaining the prompt for the LLM, evaluating the prompt, wherein evaluating the prompt comprises at least one of: determining whether an answer to the prompt exists within a database, appending predetermined inputs related to operational guidelines for the LLM to the prompt, or providing the prompt to a use-case filter configured to reject prompts unrelated to predetermined categories.

3. The method of claim 1, further comprising:
in response to determining that the metric satisfies the fault threshold, obtaining a second prompt for the LLM, wherein the second prompt is intended to reduce likelihood of the property in further output from the LLM.

4. The method of claim 3, further comprising:
based upon the second prompt, generating, using the LLM, a second output of the artificial intelligence system; and
generating, using the validation model on the second output, a second metric indicating the likelihood of the property in the second output.

5. The method of claim 4, further comprising:
determining that the second metric does not satisfy the fault threshold; and
in response to determining that the second metric does not satisfy the fault threshold, labeling the second output as trustworthy.

6. The method of claim 5, further comprising:
in response to labeling the second output as trustworthy, modifying the validation model based on the second output being trustworthy.

7. The method of claim 1, wherein the fault in the output relates to one or more of bias, hallucination, toxic behavior, threat, or readability.

8. The method of claim 1, wherein the metric indicating the likelihood of the property in the output comprises one of a Boolean value or a degree of confidence.

9. The method of claim 1, wherein obtaining the validation model comprises:
determining one or more validation metrics related to presence of the property within the output;
creating the validation model that outputs a presence indicator of the property based upon the validation metrics; and
training the validation model based on datasets containing prior examples of the validation metrics.

10. The method of claim 9, wherein training the validation model based on datasets containing prior examples of the validation metrics comprises determining that acceleration hardware is present in a computing system, and, in response to determining that acceleration hardware is present, utilizing parallelization capabilities of the acceleration hardware during training of the validation model.

11. The method of claim 1, further comprising:
in response to labeling the output as untrustworthy, outputting related factors to the likelihood of the property in the output, wherein the related factors comprise a portion of the outputs relevant to the metric or reasoning for why the metric was provided.

12. The method of claim 1, further comprising:
in response to determining that the metric satisfies the fault threshold, obtaining a second prompt for the LLM, wherein the second prompt is intended to reduce presence of the property indicating the fault in the output;
based upon the second prompt, generating, using the LLM, a second output of the artificial intelligence system;
generating, using the validation model on the second output, a second metric indicating likelihood of the property in the second output; and
based on the metric and the second metric, ranking the prompt and the second prompt.

13. The method of claim 1, wherein generating, using the validation model on the output, the metric indicating the likelihood of the property in the output comprises:
computing, by one or more pre-processing modules, a validation metric related to presence of the property within the output; and
propagating the computed metric to the validation model.

14. The method of claim 13, wherein the validation metric comprises one or more of:
semantic similarity with a reference dataset, conformance to a pre-determined principle, a sentiment analysis score, or a determination that pre-determined numeric patterns exist in the output.

15. A computing system comprising:
one or more processors;
memory; and
program instructions, stored in the memory, that upon execution by the one or more processors cause the computing system to perform operations comprising:
obtaining a prompt for a large-language model (LLM),
generating, using the LLM, an output of an artificial intelligence system;
obtaining a validation model configured to detect a property in the output, the property indicating a fault in the output;
generating, using the validation model on the output, a metric indicating likelihood of the property in the output;
determining that the metric satisfies a fault threshold; and
in response to determining that the metric satisfies the fault threshold, labeling the output as untrustworthy.

16. The computing system of claim 15, wherein the operations further comprise:
in response to determining that the metric satisfies the fault threshold, obtaining a second prompt for the LLM, wherein the second prompt is intended to reduce presence of the property indicating the fault in the output;
based upon the second prompt, generating, using the LLM, a second output of the artificial intelligence system;
generating, using the validation model on the second output, a second metric indicating likelihood of the property in the second output;
determining that the second metric does not satisfy the fault threshold; and
in response to determining that the second metric does not satisfy the fault threshold, labeling the second output as trustworthy.

17. The computing system of claim 16, wherein the operations further comprise:
in response to labeling the second output as trustworthy, modifying the validation model based on the second output being trustworthy.

18. A non-transitory computer-readable medium storing program instructions that, when executed by one or more processors of a computing system, cause the computing system to perform operations comprising:
obtaining a prompt for a large-language model (LLM),
generating, using the LLM, an output of an artificial intelligence system;
obtaining a validation model configured to detect a property in the output, the property indicating a fault in the output;
generating, using the validation model on the output, a metric indicating likelihood of the property in the output;
determining that the metric satisfies a fault threshold; and
in response to determining that the metric satisfies the fault threshold, labeling the output as untrustworthy.

19. The non-transitory computer-readable medium of claim 18, wherein the operations further comprise:
in response to determining that the metric satisfies the fault threshold, obtaining a second prompt for the LLM, wherein the second prompt is intended to reduce presence of the property indicating the fault in the output;
based upon the second prompt, generating, using the LLM, a second output of the artificial intelligence system;
generating, using the validation model on the second output, a second metric indicating likelihood of the property in the second output;
determining that the second metric does not satisfy the fault threshold; and
in response to determining that the second metric does not satisfy the fault threshold, labeling the second output as trustworthy.

20. The non-transitory computer-readable medium of claim 19, wherein the operations further comprise:
in response to labeling the second output as trustworthy, modifying the validation model based on the second output being trustworthy.
